(19) United States
(12) Patent Application Publication
(10) Pub. No.: US 2022/0086759 A1
(43) Pub. Date: Mar. 17, 2022

(54) WAKE-UP SIGNAL GROUPING BASED ON PAGING PROBABILITY

(71) Applicant: Telefonaktiebolaget LM Ericsson (publ), Stockholm (SE)

(72) Inventors: Andreas HÖGLUND, Solna (SE); Magnus ÅSTRÖM, Lund (SE)

(21) Appl. No.: 17/426,276

(22) PCT Filed: Jan. 31, 2020
(86) PCT No.: PCT/EP2020/052399

§ 371 Date: Jul. 28, 2021

Related U.S. Application Data
(60) Provisional application No. 62/799,511, filed on Jan. 31, 2019.

(51) Int. Cl. H04W 52/02; H04W 68/00

(52) U.S. Cl. CPC H04W 52/0232; H04W 68/005

(57) ABSTRACT

Wake-up signal grouping is based on a paging probability (PP) type rather than a service type to further reduce false paging. This approach enables differentiation between wireless devices with the same service type. Paging probability can be expressed as a function of the wireless devices' traffic profile, DRX, eDRX, or power saving mode (PSM) configuration, paging configuration (number of narrowbands, paging carriers, nB parameter, etc.), and other parameters.

### TECHNICAL FIELD

The present disclosure relates generally to reduction of power consumption in a wireless device based on wake-up signal grouping and, more particularly, to wake-up signal grouping based on paging probability.

### BACKGROUND

Within the Third Generation Partnership Project (3GPP), development is ongoing to specify technologies to cover Machine-to-Machine (M2M) and/or Internet of Things (IoT) related use cases. The most recent work for 3GPP Release 13 and 14 includes enhancements to support Machine-Type Communications (MTC) with new wireless device categories (Cat-M1, Cat-M2), supporting reduced bandwidth of 6 physical resource blocks (PRBs) (up to 24 PRBs for Cat-M2), and Narrowband IoT (NB-IoT) wireless devices providing a new radio interface (and wireless device categories, Cat-NB1 and Cat-NB2).

We will refer to the Long Term Evolution (LTE) enhancements introduced in 3GPP Release 13, 14 and 15 for machine-type communication (MTC) as enhanced MTC (eMTC), including (but not limited to) support for bandwidth limited wireless devices, Cat-M1, and support for coverage enhancements. This is to separate discussion from NB-IoT (notation here used for any release), although the supported features are similar on a general level.

There are multiple differences between “legacy” LTE and the procedures and channels defined for eMTC and for NB-IoT. Some important differences include new physical channels, such as the physical downlink control channels called Machine-Type Communication (MTC) Physical Downlink Control Channel (MPDCCH) in eMTC and Narrowband Physical Downlink Control Channel (NPDCCH) in NB-IoT, and a new Narrowband Physical Random Access Channel (NPRACH) for NB-IoT. Another important difference is the coverage level (also known as coverage enhancement level) that these technologies can support. By applying repetitions to the transmitted signals and channels, both eMTC and NB-IoT allow wireless device operation at much lower signal-to-noise ratios (SNRs) compared to LTE. For example, a signal energy to interference ratio (Es/IoT) of −15 dB is the lowest operating point for eMTC and NB-IoT, which can be compared to −6 dB Es/IoT for “legacy” LTE.

One work item being discussed in 3GPP for both NB-IoT and Release 15 (Rel-15) enhancement for eMTC is power consumption reductions for physical channels. For idle mode paging and connected mode discontinuous reception (DRX), reduction in power consumption can be achieved by specifying a new physical signal/channel that can be efficiently decoded and/or detected prior to decoding the physical downlink control channel (e.g., NPDCCH or MPDCCH) and/or physical downlink shared channel (e.g., Narrowband Physical Downlink shared Channel (NPDSCH)).

A wake-up signal (WUS) is based on the transmission of a short signal that indicates to the wireless device that it should continue to decode the downlink (DL) control channel e.g., full NPDCCH for NB-IoT. If such signal is absent (e.g., a wireless device in DRX does not detect it), the wireless device can go back to sleep without decoding the DL control channel. The decoding time for a wake-up signal is considerably shorter than that of the full NPDCCH, since the wake-up signal essentially only needs to contain one bit of information whereas the NPDCCH may contain up to 35 bits of information. The short decoding time for the wake-up signal, in turn, reduces wireless device power consumption and leads to longer wireless device battery life.

The use of a wake-up signal enables the wireless device to switch to an inactive or low-power mode when it is not transmitting or receiving and wake-up periodically to check for the wake-up signal. The wake-up signal is typically transmitted only when there is paging for the wireless device. If there is no paging for the wireless device, the wake-up signal is not usually transmitted (i.e., implying a discontinuous transmission (DTX)) and the wireless device can go back to sleep, e.g., upon detecting DTX instead of a wake-up signal.

In the current implementation, the wake-up signal sequence is only dependent on the time instant of the paging occasion to which the wireless device is associated and the base station, also called Evolved Node B (eNB), Cell Identification (Cell ID). This implies that it is not possible to further distinguish the wireless device or wireless devices that are being paged from other wireless devices belonging to the same paging occasion. In most cases, only a single wireless device is paged at a time, in which case the remaining wireless devices will wake up unnecessarily to monitor the subsequent MPDCCH. This unnecessary waking is referred to herein as false paging.

The Rel-15 wake-up signal was designed such that all wireless devices belong to the same group. That is, a transmitted wake-up signal associated to a specific paging occasion may wake-up all wireless devices that are configured to detect paging at that paging occasion. Hence, all wireless devices which are not targeted by the page, will wake up unnecessarily. It has been proposed to include wireless device grouping for the wake-up signal, such that the number of wireless devices that are sensitive to the wake-up signal is further narrowed down to a smaller subset of the wireless devices that are associated with a specific paging occasion.

Both eMTC and NB-IoT have been developed with varying applications in mind. Contrary to the mobile broadband (MBB) use case, the IoT realm presents widely different use cases in terms of paging rates, latency, baseband processing power, etc. In one network, a power switch for street lights effectively being paged once daily, with resulting extremely low paging rates may be deployed. In another network, a machine controlling device may be paged on a second basis. For these two networks, it is apparent that paging will differ substantially, and, consequently, that the same wireless device-grouping configuration may be ill suited.

One option under consideration for the Rel-16 wake-up signal is wireless device grouping based on wireless device identity (Device_ID) or some function of the Device_ID. Wake-up signal groups may then be based on at least legacy and a wireless device group identification (Device_GID).

One drawback of basing the wake-up signal grouping on service type is that, although two UEs have the same service, it does not necessarily follow that they have the same paging probability per paging occasion. The use of the service can be very different, the UEs can be configured with different enhanced DRX (eDRX) cycle length, so that the paging probability for them is very different.

### SUMMARY

According to one aspect of the disclosure, wake-up signal grouping is based on a paging probability (PP) type rather than a service type. This approach enables differentiation between wireless devices (e.g., UEs) with the same service type. Paging probability can be expressed as a function of the wireless device's traffic profile, DRX, eDRX, or power saving mode (PSM) configuration, paging configuration (number of narrowbands, paging carriers, nB parameter, etc.), and other parameters. A mobility management entity (MME) centric solution is proposed since the MME knows the eDRX or PSM configuration of the wireless devices and has the possibility of building up wireless device traffic profiles in order to categorize wireless devices in a configurable number of paging probability types.

The paging probability type for a wake-up signal group enabled (gWUS) wireless device is added to the wireless device context and appended to the paging information sent from MME to the eNB. Depending on the number of wake-up signal groups configured in the cell, the eNB will map the paging probability type to a wake-up signal group in a preconfigured manner and page the wireless device in that wake-up signal group. The eNB can also broadcast, as part of system information (SI), the parameters needed for the wireless device to do the same mapping (e.g., as part of the gWUS configuration) so that the wireless device can determine which wake-up signal group it should monitor for paging based on its paging probability type and ensuring that base station and wireless device use the same paging probability type to wake-up signal-group mapping.

Alternatively, in a base station centric solution, the base station categorizes wireless devices in a configurable number of paging probability types. The same or similar mapping as in the MME-centric case can be applied in this case.

In another embodiment, the MME gathers information about wireless device properties, e.g., paging statistics. The gathering can be performed for individual wireless devices or for groups of UEs with some common denominator. Based on the statistics, the MME maps the wireless device to a defined group through non-access stratum (NAS) signaling.

Wake-up signal grouping based on paging probability type reduces the false paging in order to achieve larger gains with the Rel-16 group wake-up signal feature.

A first aspect of the disclosure comprises methods implemented by a network node in a wireless communication network of configuring wake-up signaling for a wireless device. In one embodiment of the method, the network node determines a paging probability type of the wireless device based on a paging probability of the wireless device, and signals the paging probability type of the wireless device to the wireless device, a base station for the wireless device, or both.

A second aspect of the disclosure comprises a network node in a wireless communication network for configuring wake-up signaling for a wireless device. The network node is configured to determine a paging probability type of the wireless device based on a paging probability of the wireless device and signal the paging probability type of the wireless device to the wireless device, a base station for the wireless device, or both.

A third aspect of the disclosure comprises a network node in a wireless communication network for configuring wake-up signaling for a wireless device. The network node comprises a communication circuit for communicating with other network nodes in the wireless communication network and a processing circuit. The processing circuit is configured to determine a paging probability type of the wireless device based on a paging probability of the wireless device and signal the paging probability type of the wireless device to the wireless device, a base station for the wireless device, or both.

A fourth aspect of the disclosure comprises a computer program for a network node. The computer program comprises executable instructions that, when executed by a processing circuit in a network node in a wireless communication network, causes the network node to perform the method according to the first aspect.

A fifth aspect of the disclosure comprises a carrier containing a computer program according to the fourth aspect. The carrier is one of an electronic signal, optical signal, radio signal, or a non-transitory computer readable storage medium.

A sixth aspect of the disclosure comprises methods implemented by a base station in a wireless communication network of configuring wake-up signaling for a wireless device. In one embodiment, the base station obtains a paging probability type of the wireless device indicative of a paging probability of the wireless device and assigns the wireless device to one of a plurality of wake-up signal groups based at least in part on the paging probability type. In some embodiments of the method, the base station is further configured to transmit a wake-up signal addressed to the wake-up signal group to which the wireless device is assigned when it determines that a downlink transmission to the wireless device is needed.

A seventh aspect of the disclosure comprises a base station in a wireless communication network for configuring wake-up signaling for a wireless device. The base station is configured to obtain a paging probability type of the wireless device indicative of a paging probability of the wireless device and assign the wireless device to one of a plurality of wake-up signal groups based at least in part on the paging probability type.

An eighth aspect of the disclosure comprises a base station in a wireless communication network for configuring wake-up signaling for a wireless device. The base station comprises a communication circuit for communicating with wireless devices in the wireless communication network and a processing circuit. The processing circuit is configured to obtain a paging probability type of the wireless device indicative of a paging probability of the wireless device and assign the wireless device to one of a plurality of wake-up signal groups based at least in part on the paging probability type.

A ninth aspect of the disclosure comprises a computer program for a network node. The computer program comprises executable instructions that, when executed by a processing circuit in a base station in a wireless communication network, causes the base station to perform the method according to the sixth aspect.

A tenth aspect of the disclosure comprises a carrier containing a computer program according to the ninth aspect. The carrier is one of an electronic signal, optical signal, radio signal, or a non-transitory computer readable storage medium.

An eleventh aspect of the disclosure comprises methods implemented by a wireless device in a wireless communication network of configuring wake-up signaling for a wireless device. In one embodiment, the wireless device receives a paging probability type indicative of a paging probability of the wireless device and determines a wake-up signal group to which the wireless device belongs based at least in part on the paging probability type. The wireless device further monitors a downlink transmission for a wake-up signal directed to the wake-up signal group to which the wireless device belongs. In some embodiments of the method, the wireless device receives a wake-up signal addressed to the wake-up signal group to which the wireless device belongs and changes an operating mode responsive to the wake-up signal to receive a downlink transmission from the base station.

A twelfth aspect of the disclosure comprises a wireless device in a wireless communication network for configuring wake-up signaling for a wireless device. The wireless device is configured to receive a paging probability type indicative of a paging probability of the wireless device and determines a wake-up signal group to which the wireless device belongs based at least in part on the paging probability type. The wireless device is further configured to monitor a downlink transmission for a wake-up signal directed to the wake-up signal group to which the wireless device belongs.

A thirteenth aspect of the disclosure comprises a wireless device in a wireless communication network for configuring wake-up signaling for a wireless device. The wireless device comprises a communication circuit for communicating with a base station in the wireless communication network and a processing circuit. The processing circuit is configured to receive a paging probability type indicative of a paging probability of the wireless device and determines a wake-up signal group to which the wireless device belongs based at least in part on the paging probability type. The processing circuit is further configured to monitor a downlink transmission for a wake-up signal directed to the wake-up signal group to which the wireless device belongs.

A fourteenth aspect of the disclosure comprises a computer program for a network node. The computer program comprises executable instructions that, when executed by a processing circuit in a wireless device in a wireless communication network, causes the wireless device to perform the method according to the eleventh aspect.

A fifteenth aspect of the disclosure comprises a carrier containing a computer program according to the fourteenth aspect. The carrier is one of an electronic signal, optical signal, radio signal, or a non-transitory computer readable storage medium.

A sixteenth aspect of the disclosure comprises a wireless device including processing circuitry configured to perform the method according to the eleventh aspect and power supply circuitry configured to supply power to the wireless device.

A seventeenth aspect of the disclosure comprises a wireless device including processing circuitry and memory. The memory includes instructions executable by the processing circuitry whereby the wireless device is configured to perform the method according to the eleventh aspect.

An eighteenth aspect of the disclosure comprises a wireless device including an antenna configured to send and receive wireless signals, processing circuitry configured to perform the method according to the eleventh aspect, radio front-end circuitry connected to the antenna and to processing circuitry and configured to condition signals communicated between the antenna and the processing circuitry, an input interface connected to the processing circuitry and configured to allow input of information into the wireless device to be processed by the processing circuitry, an output interface connected to the processing circuitry and configured to output information from the wireless device that has been processed by the processing circuitry, and a battery connected to the processing circuitry and configured to supply power to the wireless device.

A nineteenth aspect of the disclosure comprises a base station having processing circuitry configured to perform the method according to the sixth aspect and power supply circuitry configured to supply power to the base station.

A twentieth aspect of the disclosure comprises a base station having processing circuitry and memory. The memory includes instructions executable by the processing circuitry whereby the wireless device is configured to perform the method according to the sixth aspect.

A twenty first aspect of the disclosure comprises a method implemented in a communication system including a host computer, a base station and a wireless device. In one embodiment of the method, the host computer provides user data (e.g., by executing a client application on the host computer) and initiates a transmission carrying the user data to the wireless device via a cellular network including the base station. The base station is configured to perform the method according to the sixth aspect.

A twenty second aspect of the disclosure comprises a communication system including a host computer. The host computer comprises processing circuitry configured to provide user data (e.g., by executing a client application on the host computer) and a communication interface configured to forward the user data to a cellular network for transmission to a wireless device. The cellular network comprises a base station having a radio interface and processing circuitry configured to perform the method according to the sixth aspect.

A twenty third aspect of the disclosure comprises a method implemented in a communication system including a host computer, a base station and a wireless device. In one embodiment of the method, the host computer provides user data (e.g., by executing a client application on the host computer) and initiates a transmission carrying the user data to the wireless device via a cellular network including the base station. The wireless device is configured to perform the method according to the eleventh aspect.

A twenty fourth aspect of the disclosure comprises a communication system including a host computer. The host computer comprises processing circuitry configured to provide user data (e.g., by executing a client application on the host computer) and a communication interface configured to forward the user data to a cellular network for transmission to a wireless device. The cellular network comprises a wireless device having a radio interface and processing circuitry configured to perform the method according to the eleventh aspect.

A twenty fifth aspect of the disclosure comprises a method implemented in a communication system including a host computer, a base station and a wireless device. In one embodiment of the method, the host computer receives user data transmitted to the base station from the wireless device. The wireless device is configured to perform the method according to the eleventh aspect. In some embodiments of the method, the wireless device provides the user data (e.g., by executing a client application on the wireless device). Some embodiments of the method further comprise executing, by the host computer, a host application associated with the client application.

A twenty sixth aspect of the disclosure comprises a communication system including a host computer. The host computer comprises a communication interface configured to receive user data originating from a transmission from a wireless device to a base station. The wireless device includes a radio interface and processing circuitry configured to perform the method according to the eleventh aspect.

A twenty seventh aspect of the disclosure comprises a method implemented in a communication system including a host computer, a base station and a wireless device. In one embodiment of the method, the host computer receives, from the base station, user data originating from a transmission which the base station has received from the wireless device. The wireless device is configured to perform the method according to the eleventh aspect. In some embodiments, the method further comprises receiving, by the base station, user data from the wireless device and initiating transmission of the user data to the host computer.

A twenty eight aspect of the disclosure comprises a communication system including a host computer. The host computer comprises a communication interface configured to receive user data originating from a transmission from a wireless device to a base station. The base station includes a radio interface and processing circuitry configured to perform the method according to the sixth aspect.

### BRIEF DESCRIPTION OF THE DRAWINGS

FIG. 1 illustrates a communication network implementing wake-up signal grouping based on paging probability type as herein described.

FIG. 2 illustrates an exemplary wake-up signal.

FIG. 3 illustrates a method implemented by a network node to support wake-signal groups based on paging probability type.

FIG. 4 illustrates a method implemented by a base station to support wake-signal groups based on paging probability type.

FIG. 5 illustrates a method implemented by a wireless device to support wake-signal groups based on paging probability type.

FIG. 6 illustrates an exemplary network node configured to support wake-signal groups based on paging probability type.

FIG. 7 illustrates an exemplary base station configured to support wake-signal groups based on paging probability type.

FIG. 8 illustrates an exemplary wireless device configured to support wake-signal groups based on paging probability type.

FIG. 9 illustrates an exemplary network node configured to support wake-signal groups based on paging probability type.

FIG. 10 illustrates an exemplary base station configured to support wake-signal groups based on paging probability type.

FIG. 11 illustrates an exemplary wireless device configured to support wake-signal groups based on paging probability type.

FIG. 12 illustrates an exemplary wireless network according to an embodiment.

FIG. 13 illustrates an exemplary wireless device according to an embodiment.

FIG. 14 illustrates an exemplary virtualization environment according to an embodiment.

FIG. 15 illustrates an exemplary telecommunication network connected via an intermediate network to a host computer according to an embodiment.

FIG. 16 illustrates an exemplary host computer communicating via a base station with a wireless device over a partially wireless connection according to an embodiment.

FIGS. 17-20 illustrate an exemplary method implemented in a communication system, according to an embodiment.

### DETAILED DESCRIPTION

For purposes of illustration, the techniques for grouping wireless devices, also referred to herein as UEs, into wake-up signal groups will be described in the context of a wireless communication network operating according to the NB-IoT or LTE-M standard. Those skilled in the art will appreciate that the grouping techniques are not limited to use in networks operating according to these standards but are more generally applicable to any networks using wake-up signal groups to reduce false paging.

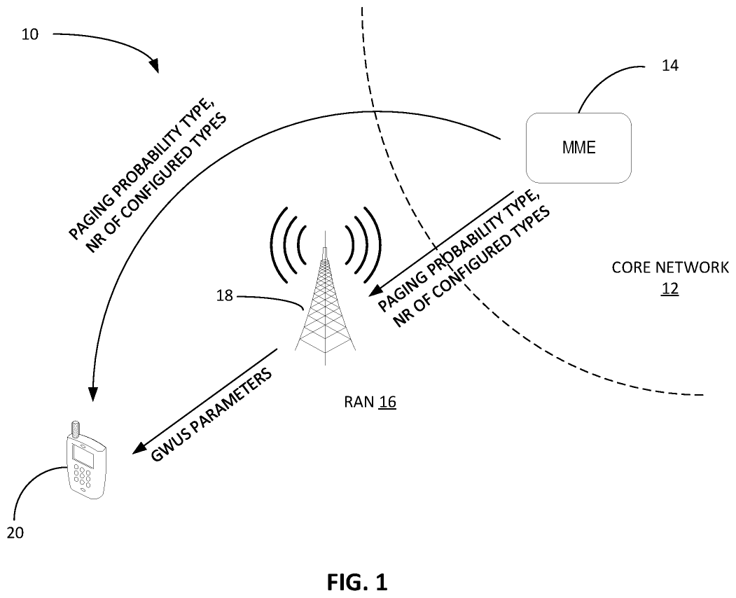

FIG. 1 illustrates the main components of a wireless communication network 10 involved in grouping wireless devices for purposes of wake-up signaling. The wireless communication network 10 generally comprises a core network 12 that includes a mobility management entity (MME) 14 and a radio access network (RAN) 16 that includes a plurality of base stations 16, which are also referred to as Evolved NodeBs (eNbs) in LTE or 5G NodeBs (gNBs) in 5G networks. The MME 14 is generally responsible for mobility management tasks, such as keeping track of the wireless device location. The base station 18 enables the wireless devices 20, also referred to herein as user equipment (UEs), served by the base station 18 to connect to the wireless communication network 10.

Power consumption of the wireless device 20 is a significant concern for end users and the network operators continue to search for ways to reduce the wireless device's power consumption. DRX is one technique used to reduce power consumption in a wireless device 20. With DRX, a wireless device 20 that is not transmitting or receiving, i.e. is inactive, is allowed to switch to a low power mode or power saving mode to conserver battery power. In the low power or power saving mode, the wireless device 20 goes to sleep and wakes-up periodically to monitor downlink transmissions. For example, in LTE the wireless device 20 may wake up periodically and decode the Physical Downlink Control Channel (PDCCH) to check whether it has been scheduled to receive a downlink transmission.

A wake-up signal is used in NB-IoT and LTE-M to further reduce power consumption. The wake-up signal is designed to be efficiently decoded and/or detected prior to decoding the physical downlink control channel and/or physical downlink shared channel (e.g., NPDCCH, NPDSCH). The wireless device 20 periodically wakes to check for the wake-up signal. If no wake-up signal is present, the wireless device 20 goes back to sleep. The decoding time for a wake-up is considerably shorter than that of the full NPDCCH, since the wake-up signal only needs to contain one bit of information, whereas the NPDCCH may contain up to 35 bits of information. The short decoding time for the wake-up signal, in turn, reduces wireless device power consumption and leads to longer wireless device battery life. Also, the wake-up signal can be detected with a simpler, wake-up receiver (WUR), allowing the main receiver to stay in sleep mode until a wake-up signal is actually received. This approach further increases power savings.

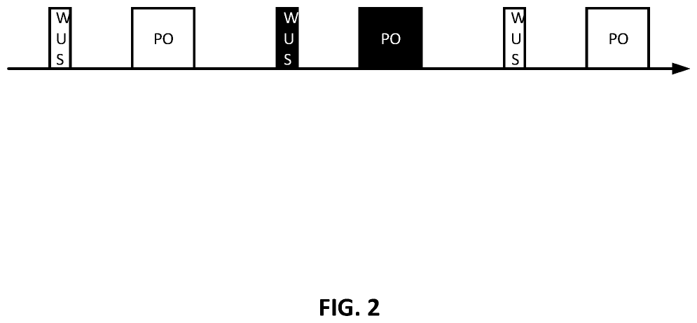

The wake-up signal is typically transmitted only when there is paging for the wireless device. If there is no paging for the wireless device, the wake-up signal is not usually transmitted and the wireless device can go back to sleep unless a wake-up signal is detected. This behavior is illustrated in FIG. 2, where white blocks indicate possible wake-up signal and paging occasion positions and the black boxes indicate actual wake-up signal and paging occasion positions.

In the current implementation, the wake-up signal or sequence is only dependent on the time instant of the paging occasion to which the wireless device 20 is associated and the base station Cell ID. This implies that it is not possible to further distinguish the wireless device or wireless devices 20 that are being paged from other wireless devices 20 belonging to the same paging occasion. In most cases only a single wireless device 20 is paged at a time, in which case the remaining wireless devices 20 will wake up unnecessarily to monitor the subsequent NPDCCH in NB-IoT or the MPDCCH in LTE-M (collectively the (N/M)PDCCH). This unnecessary waking is referred to herein as false paging.

Wake-up signal grouping is used to reduce false pages when paging a wireless device 20, i.e., to avoid waking up a wireless device 20 for which no data transmission is expected. By using multiple wake-up signal groups, there is a smaller risk that a wireless device 20 is unnecessarily awakened to read the (N/M)PDCCH and NPDSCH when another wireless device 20 is being paged.

According to the current standard, the specifications for the wake-up signal are spread out over several parts of the LTE 36-series standard, e.g., 36.211, 36.213, 36.304 and 36.331. The wake-up sequence for NB-IoT is defined in 36.211 as follows:

The NWUS sequence w(m) in subframe x=0, 1, . . . , M−1 is defined by

$$w ( m ) = {θ}_{{n}_{f} , {n}_{s}} ( {m}^{′} ) \cdot {e}^{- \frac{j π un ( n + 1 )}{131}}$$

$$m = 0 , 1 , … , 131$$

$${m}^{′} = m + 132 x$$

$$n = m mod 132$$

$${θ}_{{n}_{f} , {n}_{s}} ( {m}^{′} ) = \{ \begin{matrix}1 , if {c}_{{n}_{f} , {n}_{s}} ( 2 {m}^{′} ) = 0 and {c}_{{n}_{f} , {n}_{s}} ( 2 {m}^{′} + 1 ) = 0 \\ - 1 , if {c}_{{n}_{f} , {n}_{s}} ( 2 {m}^{′} ) = 0 and {c}_{{n}_{f} , {n}_{s}} ( 2 {m}^{′} + 1 ) = 1 \\ j , if {c}_{{n}_{f} , {n}_{s}} ( 2 {m}^{′} ) = 1 and {c}_{{n}_{f} , {n}_{s}} ( 2 {m}^{′} + 1 ) = 0 \\ - j , if {c}_{{n}_{f} , {n}_{s}} ( 2 {m}^{′} ) = 1 and {c}_{{n}_{f} , {n}_{s}} ( 2 {m}^{′} + 1 ) = 1\end{matrix} \\ u = ( {N}_{ID}^{Ncell} mod 126 ) + 3$$

where M is the actual duration of NWUS as defined in 3GPP TS 36.213.

The scrambling sequence cₙ_{_{f}}_{,n}_{ₛ}(i), i=0, 1, . . . , 2·132M−1 is given by clause 7.2, and shall be initialized at the start of the NWUS with

$${c}_{init \_ WUS} = ( {N}_{ID}^{Ncell} + 1 ) ( ( 10 {n}_{f \_ start \_ PO} + ⌊ \frac{{n}_{s \_ start \_ PO}}{2} ⌋ ) mod 2048 + 1 ) {2}^{9} + {N}_{ID}^{Ncell}$$

where n_{f_start_PO} is the first frame of the first PO to which the NWUS is associated, and n_{s_start_PO} is the first slot of the first PO to which the NWUS is associated.

And further:

. . . the NWUS sequence w(m) shall be mapped to resource elements (k, l) in sequence, starting with w(0) in increasing order of first the index k=0, 1, . . . , N_{sc}^{RB}−1, over the 12 assigned subcarriers and then the index l=3, 4, . . . , 2N_{symb}^{DL}−1 in each subframe in which NWUS is transmitted.

In the current implementation, the wake-up signal sequence is only dependent on the time instant of the paging occasion to which the wireless device 20 is associated and the base station Cell ID. This implies that it is not possible to further distinguish the wireless device or wireless devices that are being paged from other UEs 20 belonging to the same paging occasion. In most cases only a single wireless device 20 is paged at a time, in which case the remaining wireless devices 20 will wake up unnecessarily to monitor the subsequent NPDCCH. This unnecessary waking is referred to herein as false paging.

It has been proposed to classify wireless devices 20 based on service type and assign them to wake-up signal groups based on the service type. That two wireless devices 20 have the same service type, however, does not at all mean they will have the same paging probability. Paging probability as used herein refers to the likelihood that that a specific wireless device 20 will be paged in any given paging occasion with which it is associated. The traffic profiles for wireless devices 20 having the same service type can be very different. For example, an on/off actuator for a machine in a factory could turn the machine on and off every few seconds. In contrast, an on/off actuator for a street lamp may turn the street light on and off once per day. Even if the service and the traffic profile are the same, the paging probability will depend on the DRX, eDRX or PSM configuration. As an example, in the above example, where the eDRX cycle for one wireless device 20 may be half of that of another wireless device 20 will in principle have twice as high paging probability.

Therefore, according to one aspect of the disclosure, for purposes of wake-up signal grouping, the wireless devices 20 are classified based on a paging probability and assigned to wake-up signal groups based on paging probability type rather than just a service type or traffic type. The paging probability type is based on parameters that enable differentiation between wireless devices 20 with the same service type, such as a traffic type or traffic profile associated with the wireless device 20, a DRX configuration of the wireless device 20, a PSM configuration of the wireless device 20, a paging configuration of the wireless device 20, a number of carriers used for paging, or a mobility of the wireless device 20. Grouping wireless devices 20 based on paging probability will reduce false paging.

The paging probability of a wireless device 20 can be determined in a network node (e.g., MME 14 or base station 18) as a function of multiple factors, which may include service type. Parameters that may be used for determining the paging probability and/or paging probability type of the wireless device 20 include:
Parameters known by the MME 14:
   The wireless devices 20 traffic profile, data transaction history, or other traffic statistics.
   wireless device subscription information, e.g. the Rel-15 ‘Subscription Based wireless device Differentiation Information’;
   The DRX cycle length of the wireless device 20;
   The eDRX configuration of the wireless device 20 (eDRX cycle length, Paging Time Window length, etc.);
   The PSM configuration of the wireless device 20 (Traffic Area Update (TAU) periodic timer, active window, etc.);
   The wake-up signal configuration of the wireless device 20;
   Paging escalation, i.e. the number of cells a wireless device 20 is paged in (from 1 to entire traffic area (TA));
   Mobility properties;
Parameters known by base station 18:
   The number of narrowbands used for paging (LTE-M);
   The number of paging carriers (NB-IoT);
   Paging weights (NB-IoT);
   The paging/PCCH configuration (parameters nB, defaultPaingCycle, etc.);
   The wake-up signal gaps applied for DRX, eDRX-long, and eDRX-short;
Estimated parameters not known by either the base station 18 or MME 14:
   Number of wireless devices 20 camping on the cell.

With respect to the last bullet, the total number of wireless devices 20 and their respective paging probabilities, are known to the network 10. Hence, the network 10 may make certain assumptions regarding the number of wireless devices 20 in a cell and the paging probabilities of those wireless devices 20, e.g., determine the average number of wireless devices 20 or a weight in combination with the average and the paging probabilities of the average in order to determine suitable boundaries of the paging probability based paging to achieve a fair paging mechanism

The discussion so far assumes that paging probability is independent among wireless devices 20, which may not always be the case. For example, the pages for two wireless devices 20 in the same factory could be internally phase-shifted such that they present the same statistics, but it would still be little benefit from grouping them together. In fact, false paging is likely reduced by not grouping them together. Their paging patterns coinciding in the paging frequency domain but are orthogonal in the paging time domain. Such dependencies can be discovered by correlation analysis, Markov chains or Autoregressive Moving Average (ARMA) modelling of two or more wireless devices 20. Thus, in addition to paging probability, other factors may also be considered in wake-up signal grouping.

Another consideration for grouping is false paging, i.e. the unnecessary waking of a wireless device 20 to page a different wireless device 20. Mobility of a wireless device 20 is one parameter that can cause false paging. Therefore, separating wireless devices 20 into different groups based on mobility can reduce false paging. The rationale for separating mobile wireless devices 20 from stationary wireless devices 20 is that mobile wireless devices 20 are much more likely to require paging escalation, which will wake up wireless devices 20 in cells other than the last known cell. By doing group differentiation based on mobility, stationary wireless devices 20 in neighboring cells do not need to suffer from paging escalations due to mobile wireless devices 20 while mobile wireless devices 20 must be expected to tolerate such escalations.

The false paging for a wireless device 20 in a paging occasion depends on the number of wireless devices 20 sharing that paging occasion, the paging probability per paging occasion for the other wireless devices 20 and the mobility of the wireless devices 20. The potential gain from wake-up signal grouping based on paging probability, as opposed to service type, comes from reducing the probability that a wireless device 20 with low paging probability shares the paging occasion with a wireless device 20 with high paging probability. For a wireless device 20 with high paging probability the false paging is less important since it is often paged itself. From a system point of view, false pages can be optimized according to a metric. This metric may be minimizing the total number of false pages or related to fairness, e.g., an approximately constant ratio between pages and false pages for all wireless devices 20 in a group such that the relation between the pages and the false pages is approximately equal for all wireless devices 20.

The number of wireless devices 20 sharing a paging occasion is in principle known to base station 18 from the paging configuration, that is, how the space of all wireless device_IDs are distributed over the configured Paging Frames (PF) and paging occasions. The base station 18 does not know how many wireless devices 20 are camping on the cell but has statistical and load information.

The base station 18 does in general not keep track of wireless devices 20 when they are not in a Radio Resource Control (RRC) Connected (RRC_CONNECTED) state, i.e. the wireless device 20 context is released by the base station 18 when wireless devices 20 return to the RRC Idle (RRC_IDLE) state, with the exception for RRC Suspend/Resume, a.k.a. cellular IoT (CIoT) user plane optimization, possible proprietary solutions, etc.). MME 14, on the other hand, keeps the wireless device 20 context when the wireless device 20 is registered in the Tracking Area (TA). Therefore, the MME 14 could build up and store a traffic profile for wireless devices 20, but it does not know how many wireless devices 20 will share a paging occasion because it does not know the paging configuration in base station 18. Further, with regards to determining the paging probability, the MME 14 knows the eDRX and PSM configuration, but not the DRX configuration. False paging could be reduced considering eDRX and PSM wireless devices 20 since only their paging probability is known. These solutions, however, depend on DRX or the defaultPagingCycle for eDRX that is applied within the Paging Time Window (PTW), and on the PSM within the active time. However, the defaultPagingCycle in a cell is common to all wireless devices 20 in the cell. Therefore, the MME 14 would be able to estimate from the traffic profile of a wireless device 20 and the DRX, eDRX or PSM configuration, a measure of that wireless devices 20 paging probability (but not per paging occasion).

The MME 14 can configure a number of paging probability categories and divide all gWUS enabled wireless devices 20 to respective categories, ranging from low paging probability to high paging probability. A paging probability type for the wireless device 20 is in accordance with this aspect is added to the wireless device 20 context by the MME 14. The paging probability type can be communicated to the wireless device 20 using non-access stratum (NAS) signaling. The MME 14 may also signal the number of configured paging probability types, which is required for the mapping described below. When a wireless device or group of wireless devices 20 is paged, the paging probability type is included in the wireless device 20 radio paging capabilities in the paging message sent from MME 14 to base station 18. The base station 18 receives this information on the wireless device paging probability type and maps the paging probability type to a wake-up signal group selected from among the wake-up signal groups configured in the cell. The number of wake-up signal groups and/or paging probability types could in principle be configurable.

In one embodiment, the mapping of paging probability types to wake-up signal groups can be specified by standard, e.g., in a table or formula, and any parameters needed to perform such mapping can be broadcast in System Information (SI) (most naturally with all the other gWUS parameters to be added in Rel-16). Note that MME 14 needs to communicate the number of configured paging probability types to the base station 18. The predetermined mapping enables the wireless device 20 to apply the same mapping as the base station 18, i.e. using the gWUS signal parameters in SI and its paging probability type as communicated by the MME 14 over NAS. Thus, the wireless device 20 is able to wake up to monitor for the wake-up signal according to its wake-up signal group, which is also known to the base station 18.

In general, the mapping is such that the wake-up signal group of a wireless device 20 is determined as a function of the paging probability type of the wireless device 20, the configured number of paging probability types, and the configured number of wake-up signal groups. Other factors may also be considered in determining the paging probability type. If the configured number of paging probability types (NrPpt) is the same at the configured number of wake-up signal groups (NrWusG) the mapping is obvious; NrPpt=NrWusG. In this embodiment, the NrPpt parameter needs to be communicated from MME 14 to base station 18. In an alternative embodiment, NrWusG could be communicated from base station 18 to MME 14.

If the configured number of paging probability types is larger than configured number of wake-up signal groups, i.e., NrPpt>NrWusG, multiple paging probability types would be paged in the same wake-up signal group. There is no ambiguity in this case since the wake-up signal group is clearly defined and the wireless device 20 and base station 18 share the same understanding. Exemplary mappings that could be used are given in the tables below. (Note that NrPpt=1 or NrWusG=1 is not included below since no mapping is needed, and that the case where NrPpt=NrWusG is incorporated in the same table).

TABLE 1
NrWusG = 2

| | Paging probability type: | | |
|---|---|---|---|
| WUS group: | NrPpt = 2 | NrPpt = 4 | NrPpt = 8 |
| 1 | 1 | 1, 2 | 1, 2, 3, 4 |
| 2 | 2 | 3, 4 | 5, 6, 7, 8 |

TABLE 2
NrWusG = 4.

| | Paging probability type: | | |
|---|---|---|---|
| WUS group: | NrPpt = 4 | NrPpt = 8 | NrPpt = 16 |
| 1 | 1 | 1, 2 | 1, 2, 3, 4 |
| 2 | 2 | 3, 4 | 5, 6, 7, 8 |
| 3 | 3 | 5, 6 | 9, 10, 11, 12 |
| 4 | 4 | 7, 8 | 13, 14, 15, 16 |

TABLE 3
NrWusG = 8.

| | Paging probability type: | | |
|---|---|---|---|
| WUS group: | NrPpt = 8 | NrPpt = 16 | NrPpt = 32 |
| 1 | 1 | 1, 2 | 1, 2, 3, 4 |
| 2 | 2 | 3 ,4 | 5, 6, 7, 8 |
| 3 | 3 | 5, 6 | 9, 10, 11, 12 |
| 4 | 4 | 7, 8 | 13, 14, 15, 16 |
| 5 | 5 | 9, 10 | 17, 18, 19, 20 |
| 6 | 6 | 11, 12 | 21, 22, 23, 24 |
| 7 | 7 | 13, 14 | 25, 26, 27, 28 |
| 8 | 8 | 15, 16 | 29, 30, 31, 32 |

If the configured number of paging probability types is smaller than configured number of wake-up signal groups, NrPpt<NrWusG, it is not possible to map a paging probability type to multiple wake-up signal groups so there is ambiguity in this case. In one embodiment, this ambiguity is resolved by restricting either base station 18 from configuring NrWusG to a higher value than NrPpt as communicated by the MME 14. Alternatively, the MME 14 can be restricted from configuring NrPpt to a smaller value than NrWusG as communicated by base station 18.

In one embodiment, wireless devices 20 with the same paging probability type can be split into two or more wake-up signal groups, such that all available wake-up signal groups are utilized. The group to be split may be determined by, e.g., number of wireless devices 20 in the group, estimated false alarm rate, prioritization, mobility, etc.

In another embodiment for NrPpt<NrWusG other information of the wireless device 20 is used in this case to further differentiate the wake-up signal group and have a clearly defined wake-up signal group for each paging probability type.

Table 4 below is an example of how the wireless device_ID being just for this further differentiation (wireless device 20_ID based on IMSI as in 3GPP TS 36.304 V15.2.0):

TABLE 4
NrWusG = 4 for NrPpt < NrWusG.

| WUS | Paging probability type: | | |
|---|---|---|---|
| group: | NrPpt = 1 | NrPpt = 2 | NrPpt = 4 |
| 1 | 1, wireless device | 1, wireless device | 1 |
| | 20_ID mod 4 = 0 | 20_ID mod 2 = 0 | |
| 2 | 1, wireless device | 1, wireless device | 2 |
| | 20_ID mod 4 = 1 | 20_ID mod 2 = 1 | |
| 3 | 1, wireless device | 2, wireless device | 3 |
| | 20_ID mod 4 = 2 | 20_ID mod 2 = 0 | |
| 4 | 1, wireless device | 2, wireless device | 4 |
| | 20_ID mod 4 = 3 | 20_ID mod 2 = 1 | |

This mapping can be generalized to wireless device_ID mod NrWusG=i, where i is in the range {0, . . . , NrPpt−1}.

Because wireless device_ID bits are already used for determining PF/PO, paging carrier (NB-IoT)/narrowband, etc., interdependencies should preferably be avoided. That is, the above embodiment may result in all wireless devices in a paging occasion will be put in WUS group 1 and 3 and no wireless devices 20 will be allocated to WUS groups 2 and 4. To avoid this, other wireless device_ID bits could be used instead to ensure there is a uniform distribution of the wake-up signal groups. One example is given in Table 5 below.

TABLE 5
NrWusG = 4 for NrPpt < NrWusG

| WUS | Paging probability type: | | | | |
|---|---|---|---|---|---|
| group: | NrPpt = 1 | NrPpt = 2 | NrPpt = 4 | NrPpt = 8 | NrPpt = 16 |
| 1 | 1, floor(wireless device | 1, floor(wireless device | 1 | 1, 2 | 1, 2, 3, 4 |
| | 20_ID/Nn) mod Nw = 0 | 20_ID/Nn) mod Nw = 0 | | | |
| 2 | 1, floor(wireless device | 1, floor(wireless device | 2 | 3, 4 | 5, 6, 7, 8 |
| | 20_ID/Nn) mod Nw = 1 | 20_ID/Nn) mod Nw = 1 | | | |
| 3 | 1, floor(wireless device | 2, floor(wireless device | 3 | 5, 6 | 9, 10, 11, |
| | 20_ID/Nn) mod Nw = 2 | 20_ID/Nn) mod Nw = 0 | | | 12 |
| 4 | 1, floor(wireless device | 2, floor(wireless device | 4 | 7, 8 | 13, 14, |
| | 20_ID/Nn) mod Nw = 3 | 20_ID/Nn) mod Nw = 1 | | | 15, 16 |

In Table 5, Nw=NrWusG. Note that some of the examples given above rely on the fact that the paging probability is increasing (or decreasing) with the number of the paging probability types.

In a base station centric embodiment, the base station 18 categorizes wireless devices 20 in a configurable number of paging probability types. The number of paging probability types can be determined by base station 18 and only valid in that cell, or can be determined by the MME 14 and be valid in the entire tracking area. In the first case, base station 18 determines both the number of paging probability types and the number of the wake-up signal groups in the cell, and any of the mappings described above can be applied to have a common understanding between the wireless device 20 and base station 18 about the wireless device's wake-up signal group (possibly RRC configuration which remains valid after the wireless device 20 returns to RRC_IDLE can be applied). The second case is the similar but the base station 18 will instead use the number of paging probability types as determined and communicated by the MME 14.

The difference in the base station centric solution is that it is the base station 18 that builds up the wireless device traffic profile is able to categorize the wireless device 20 to one of the paging probability types. The paging probability type of the wireless device 20 and traffic profile information can be added to the wireless device 20 context, either stored in base station 18 (e.g. for CIoT UP-optimization or RAN paging in NR RRC_INACTIVE), or MME 14 is transparently storing the information.

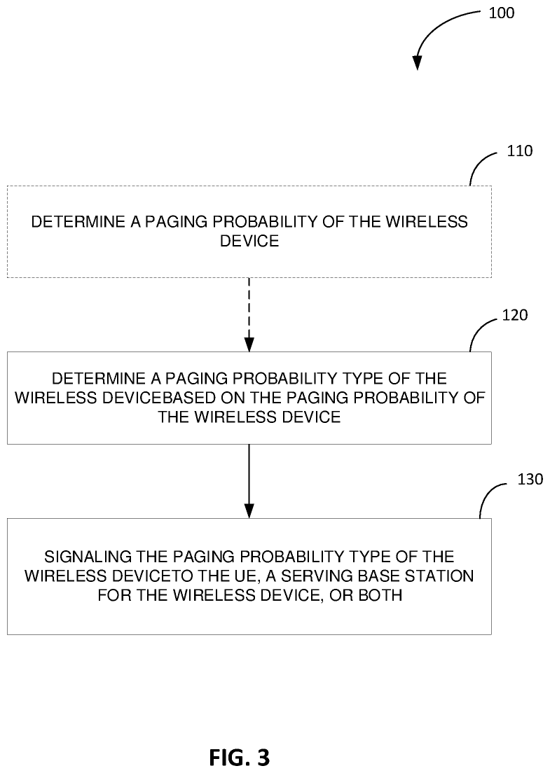

FIG. 3 illustrates an exemplary method 100 implemented by a network node in wireless communication network 10 to support wake signal groups based on paging probabilities of the wireless devices 20. The method can be implemented, for example, by an MME 14 or other core network node, or by a base station 18. The network node optionally determines a paging probability for wireless device 20 based on factors that differentiate the paging probabilities for wireless devices 20 having the same service type (block 110). Based on the paging probability of the wireless device 20, the network node determines a paging probability type of the wireless device 20 (block 120). The network node signals the determined paging probability type of the wireless device 20 to the wireless device 20, a base station 18 for the wireless device 20, or both (block 130).

The paging probability and/or paging probability type can be determined based on at least one of based on at least one of a traffic type associated with the wireless device 20, a discontinuous reception configuration of the wireless device 20, a PSM configuration of the wireless device 20, a paging configuration of the wireless device 20, a number of carriers used for paging, or a mobility of the wireless device 20.

In some embodiments of the method 100, the paging probability or paging probability type is determined by an MME 14 or other core network node. The MME 14 signals the paging probability or paging probability type to the wireless device 20 in a NAS message. The MME 14 may also signals the paging probability or paging probability type to the base station 18 with a paging message. The paging probability type may be received, for example, with a paging message. The paging probability or paging probability type may be included in the paging message or appended to the paging message. As another example, the paging probability type can be received in the same transmission as the paging message.

In other embodiments of the method 100, the paging probability type is determined by a base station 18 or other network node in the RAN. The base station 18 signals the paging probability type to the wireless device 20.

In some embodiments of the method 100, determining the paging probability type is further based on a false paging cost. The false paging cost is determined, for example, based on factors such as mobility of the wireless device 200, WUS configuration of the wireless device 20, paging escalation strategy, number of paging narrowbands or paging subcarriers, paging weights, paging/PDCCH configuration, WUS gap configuration of the cell/network, and/or determined number of wireless devices 20 camping on the cell.

In some embodiments of the method 100, the MME 14 or base station 18 further signals a number of paging probability types to the wireless device 20 in addition to the paging probability of the wireless device 20. The number of paging probability types can be signaled in the same message used to signal the paging probability type, or in a different message.

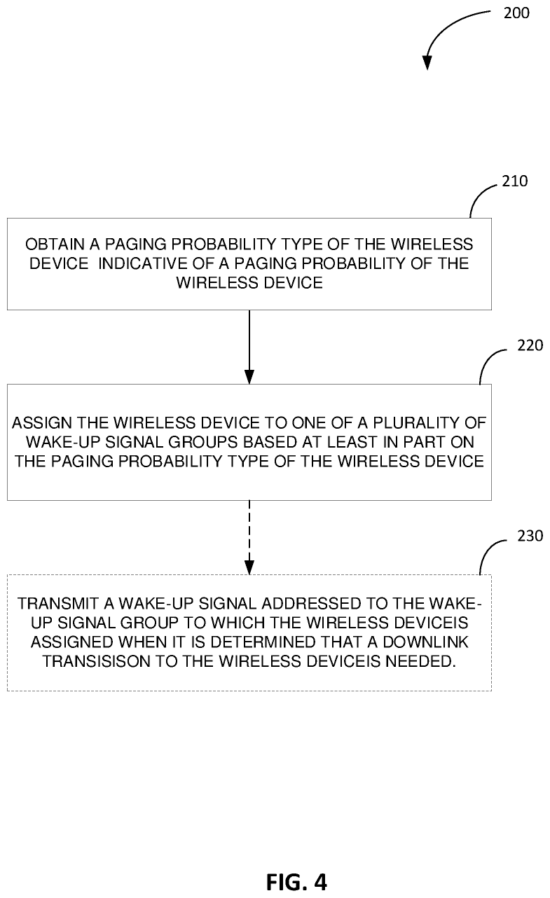

FIG. 4 illustrates an exemplary method 200 implemented by a base station 18 in wireless communication network 10 to support wake signal groups based on paging probabilities of the wireless devices 20. The base station 18 obtains a paging probability type of the wireless device 20 indicative of a paging probability of the wireless device 20 (block 210). The base station 18 assigns the wireless device 20 to one of a plurality of wake-up signal groups based at least in part on the paging probability type (block 220). The base station 18 optionally transmits a wake-up signal addressed to the wake-up signal group to which the wireless device 20 is assigned when it determines that there is a downlink transmission for the wireless device 20 (block 230).

In some embodiments of the method 200, the base station 18 determines a paging probability of the wireless device 20. The base station 18 then determines a paging probability type of the wireless device 20 based on a paging probability of the wireless device 20.

In other embodiments of the method 200, the base station 18 receives the paging probability type from a mobility management entity in the wireless communication network, or from another core network node. For example, the base station 18 receives the paging probability type with a paging message sent by an MME. The paging probability type may be included in the paging message or appended to the paging message. As another example, the paging probability type can be received in the same transmission as the paging message.

In some embodiments of the method 200, the base station 18 assigns the wireless device 20 to a wake-up signal group by applying a known mapping between paging probability types and wake-up signal groups. For example, the mapping may be specified by standards, or determined by a management entity in the core network.

In some embodiments of the method 200, the mapping may be dependent on a number of paging probability types. In cases where a number of paging probability types exceeds a number of wake-up signal groups, the mapping associates two or more paging probability types to at least one of the wake-up signal groups. In cases where a number of paging probability types is less than a number of wake-up signal groups, the mapping splits wireless devices 20 associated with at least one paging probability type between two or more wake-up signal groups. For example, the mapping can split the wireless devices 20 associated with one of the paging probability types between two or more wake-up signal groups based on a wireless device 20 identification.

In some embodiment of the method 200, the base station 18 receives the number of paging probability types from the MME 14 or other core network node.

In some embodiments of the method 200, the base station 18 further transmits a wake-up signal addressed to the WUS group to which the wireless device 20 is assigned when there is a need to page the wireless device 200.

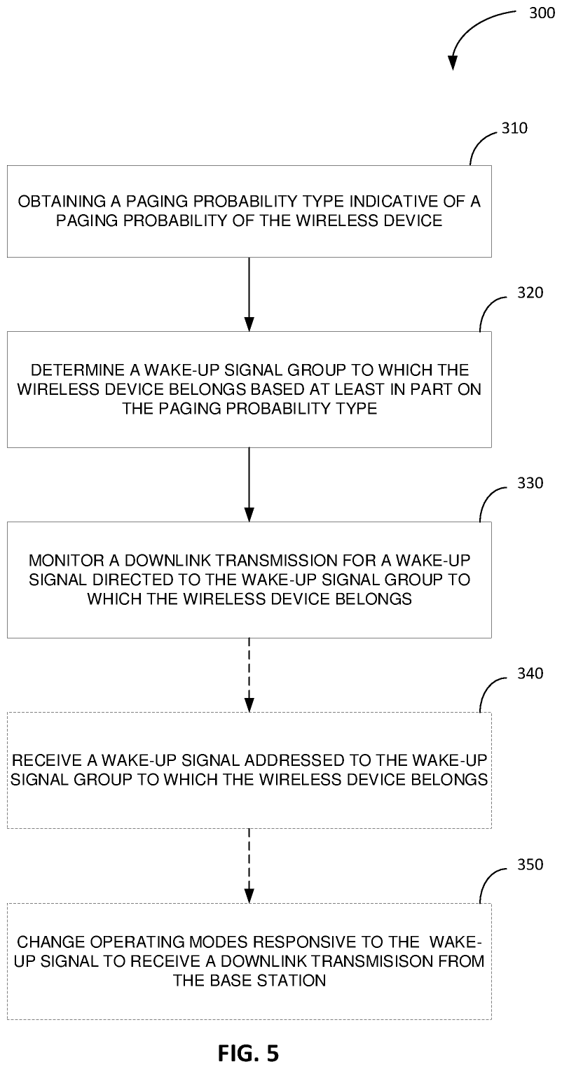

FIG. 5 illustrates an exemplary method 300 implemented by a wireless device 20. The wireless device 20 obtains a paging probability type indicative of a paging probability of the wireless device 20 (block 310). The wireless device 20 then determines a wake-up signal group to which the wireless device 20 belongs based at least in part on the paging probability type (block 320), and monitors a downlink transmission for a wake-up signal directed to the wake-up signal group to which the wireless device 20 belongs (block 330). The wireless device 20 may optionally receive a wake-up signal addressed to the wake-up signal group to which the wireless device 20 belongs (block 340). Responsive to the wake-up signal, the wireless device 200 may optionally change an operating mode responsive to the wake-up signal to enable the wireless device 20 to receive a downlink transmission intended for the wireless device 20 (block 350).

In some embodiments of the method 500, the paging probability type is received from a mobility management entity in the wireless communication network via non-access stratum signaling. In other embodiments, the paging probability type is received from a base station 18.

In some embodiments of the method 300, determining a wake-up signal group to which the wireless device 20 belongs comprises applying a known mapping between paging probability types and wake-up signal groups. For example, the mapping may be specified by standards, or determined by a management entity in the core network.

In some embodiments of the method 300, the mapping between paging probability types and wake-up signal groups may be dependent on a number of paging probability types. In cases where a number of paging probability groups exceeds a number of wake-up signal groups, the mapping associates two or more paging probability groups to at least one of the wake-up signal groups. In cases where a number of paging probability groups is less than a number of wake-up signal groups, the mapping splits wireless devices 20 associated with at least one paging probability type between two or more wake-up signal groups. In one embodiment, the mapping splits the wireless devices 20 associated with one of the paging probability types between two wake-up signal groups based on a wireless device 20 identification (e.g., IMSI).

In some embodiments, the method 300 further comprises receiving the number of paging probability groups from one of a mobility management entity and a base station 18 for the wireless device 20.

In some embodiments of the method 300, the wireless device 20 can change from a sleep mode or low power mode to an active mode responsive to the wake-up signal in order to receive a downlink transmission intended for the wireless device 20. If the wireless device 20 is in an idle mode, the wireless device 20 may wake up in order to receive an incoming call. If the wireless device 20 is in a connected mode, the wireless device 20 may wake up in order to receive a downlink transmission on the PDSCH.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Apparatuses configured to perform the methods as herein described can be implemented by any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

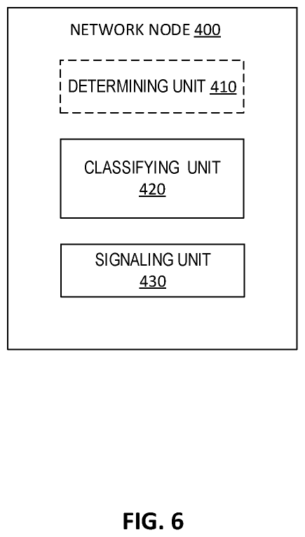

FIG. 6 illustrates a network node 400 configured to perform the method 100 of FIG. 3. The network node 400 comprises an optional paging probability (PP) determining unit 410, a classifying unit 420 and a signaling unit 430. The units 410-430 can be implemented by hardware and/or by software code that is executed by one or more processors or processing circuits. The determining unit 410 is configured to determine a paging probability for wireless device 20 based on factors that differentiate the paging probabilities for wireless devices 20 having the same service type. The classifying unit 420 is configured to determine a paging probability type of the wireless device 20 based on the paging probability of the wireless device 20. The signaling unit 430 is configured to signal the determined paging probability type of the wireless device 20 to the wireless device 20, a base station 18 for the wireless device 20, or both.

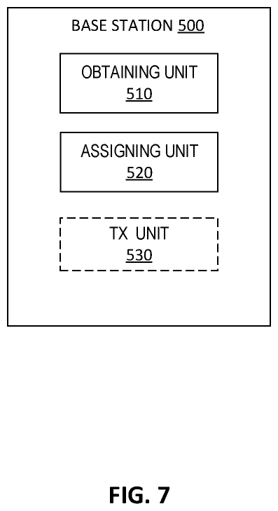

FIG. 7 illustrates a base station 500 configured to perform the method 200 of FIG. 4. The base station 500 comprises on obtaining unit 510, an assigning unit 520 and an optional transmitting unit 530. The units 510-530 can be implemented by hardware and/or by software code that is executed by one or more processors or processing circuits. The obtaining unit 510 is configured to obtain a paging probability type of the wireless device 20 indicative of a paging probability of the wireless device 20. The assigning unit 520 is configured to assign the wireless device 20 to one of a plurality of wake-up signal groups based at least in part on the paging probability type. The transmitting unit 530 is configured to transmit a wake-up signal addressed to the wake-up signal group to which the wireless device 20 is assigned when it determines that there is a downlink transmission for the wireless device 20.

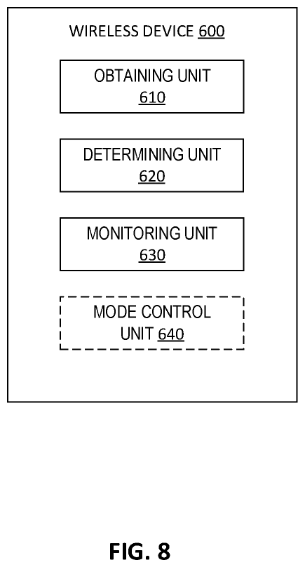

FIG. 8 illustrates a wireless device 600 configured to perform the method 300 of FIG. 5. The wireless device 600 comprises an obtaining unit 610, a determining unit 620, a monitoring unit 630 and an optional mode control unit 640. The units 610-640 can be implemented by hardware and/or by software code that is executed by one or more processors or processing circuits. The obtaining unit 610 is configured to receive a paging probability type indicative of a paging probability of the wireless device 20. The determining unit 620 is configured to determine a wake-up signal group to which the wireless device 20 belongs based at least in part on the paging probability type. The monitoring unit 630 is configured to monitor a downlink transmission for a wake-up signal directed to the wake-up signal group to which the wireless device 20 belongs. The optional mode control unit 640 is configured to change an operating mode responsive to detecting a wake-up signal addressed to the wake-up signal group to which the wireless device 20 belongs

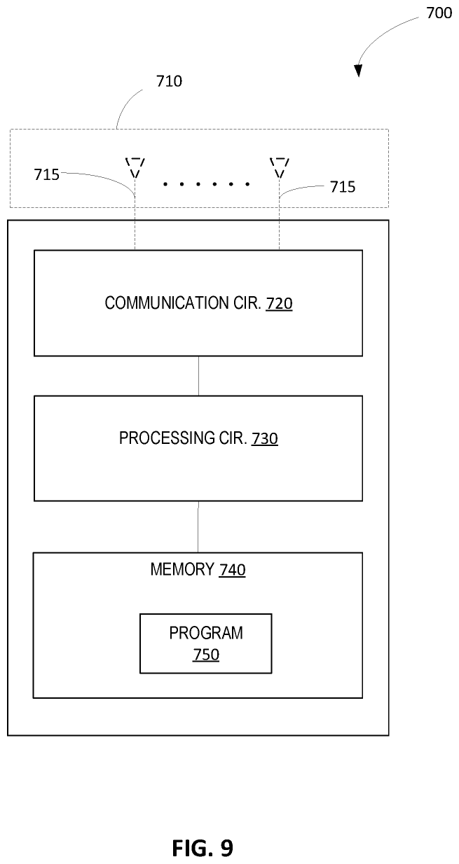

FIG. 9 illustrates an exemplary network node 700 configured to perform the method 100 shown in FIG. 3. The network node 700 comprises a communication circuit 720, a processing circuit 730, and memory 740.

The communication circuit 720 enables communication with other network nodes over wired or wireless networks. In some embodiments, where the network node 700 comprises as a base station 18, the communication circuit 720 further comprises the radio frequency (RF) circuitry needed for transmitting and receiving signals over a wireless communication channel.

The processing circuit 730 controls the overall operation of the network node 700 and can be configured to perform the method 100 shown in FIG. 3. The processing circuit 730 may comprise one or more microprocessors, hardware, firmware, or a combination thereof.

Memory 740 comprises both volatile and non-volatile memory for storing computer program code and data needed by the processing circuit 730 for operation. Memory 740 may comprise any tangible, non-transitory computer-readable storage medium for storing data including electronic, magnetic, optical, electromagnetic, or semiconductor data storage. Memory 740 stores a computer program 750 comprising executable instructions that configure the processing circuit 730 to implement one the method 100 shown in FIG. 3. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 750 for configuring the processing circuit 730 as herein described may be stored in a removable memory, such as a portable compact disc, portable digital video disc, or other removable media. The computer program 750 may also be embodied in a carrier such as an electronic signal, optical signal, radio signal, or computer readable storage medium.

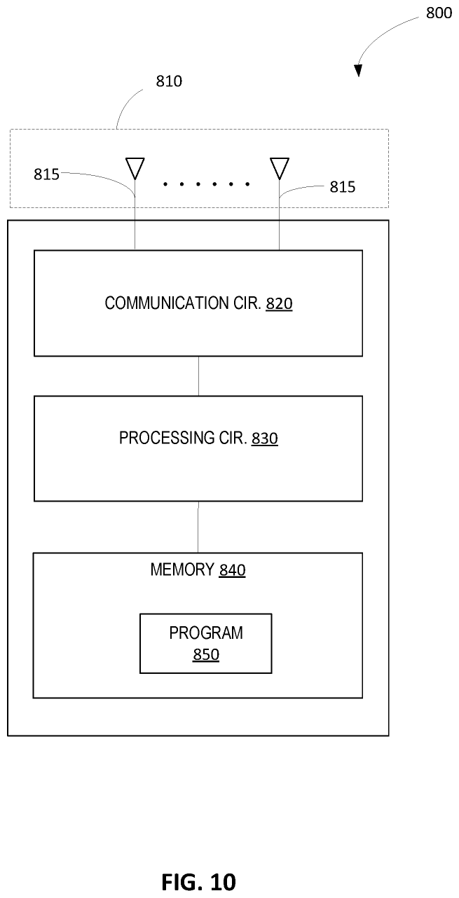

FIG. 10 illustrates an exemplary base station 800 configured to perform the method 200 of FIG. 4. The base station 800 comprises an antenna array 810 comprising one or more antennas 815, a communication circuit 820, a processing circuit 830, and memory 840.

The communication circuit 820 enables the base station 800 to communicate with wireless devices 20 served by the base station 800. The communication circuit 820 incudes radio frequency (RF) circuitry needed for transmitting and receiving signals over a wireless communication channel. The RF circuitry may, for example, be configured to operate according to the NB-IoT or LTE-M standards. The communication circuit 820 may further include interface circuits to enable the base station 18 800 to communicate with other network nodes over a communication network (e.g., backhaul) The processing circuit 830 controls the overall operation of the base station 18 800 and can be configured to perform the method 200 shown in FIG. 4. The processing circuit 830 may comprise one or more microprocessors, hardware, firmware, or a combination thereof.

Memory 840 comprises both volatile and non-volatile memory for storing computer program code and data needed by the processing circuit 830 for operation. Memory 840 may comprise any tangible, non-transitory computer-readable storage medium for storing data including electronic, magnetic, optical, electromagnetic, or semiconductor data storage. Memory 840 stores a computer program 850 comprising executable instructions that configure the processing circuit 830 to implement the method 200 according to FIG. 4. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 850 for configuring the processing circuit 830 as herein described may be stored in a removable memory, such as a portable compact disc, portable digital video disc, or other removable media. The computer program 850 may also be embodied in a carrier such as an electronic signal, optical signal, radio signal, or computer readable storage medium.

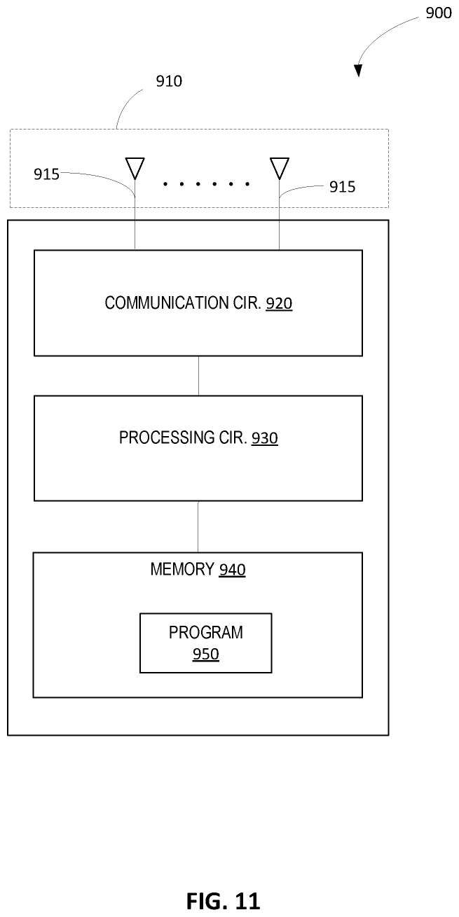

FIG. 11 illustrates an exemplary wireless device 900 configured to perform the method 300 of FIG. 5. The wireless device 900 comprises an antenna array 910 comprising one or more antennas 915, a communication circuit 920, a processing circuit 930, and memory 940.

The communication circuit 920 enables the wireless device 900 to communicate with the base station 18 16. The communication circuit 920 incudes radio frequency (RF) circuitry needed for transmitting and receiving signals over a wireless communication channel. The RF circuitry may, for example, be configured to operate according to the NB-IoT or LTE-M standards.

The processing circuit 930 controls the overall operation of the base station 18 900 and can be configured to perform the method 300 shown in FIG. 5. The processing circuit 930 may comprise one or more microprocessors, hardware, firmware, or a combination thereof.

Memory 940 comprises both volatile and non-volatile memory for storing computer program code and data needed by the processing circuit 930 for operation. Memory 940 may comprise any tangible, non-transitory computer-readable storage medium for storing data including electronic, magnetic, optical, electromagnetic, or semiconductor data storage. Memory 940 stores a computer program 950 comprising executable instructions that configure the processing circuit 930 to implement the method 300 according to FIG. 5. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 950 for configuring the processing circuit 930 as herein described may be stored in a removable memory, such as a portable compact disc, portable digital video disc, or other removable media. The computer program 950 may also be embodied in a carrier such as an electronic signal, optical signal, radio signal, or computer readable storage medium.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

Although the invention above is written with NB-IoT and LTE-M in mind, it would be equally applicable to NR in RRC_IDLE and RRC_INACTIVE (using RAN paging).

### Additional Embodiments

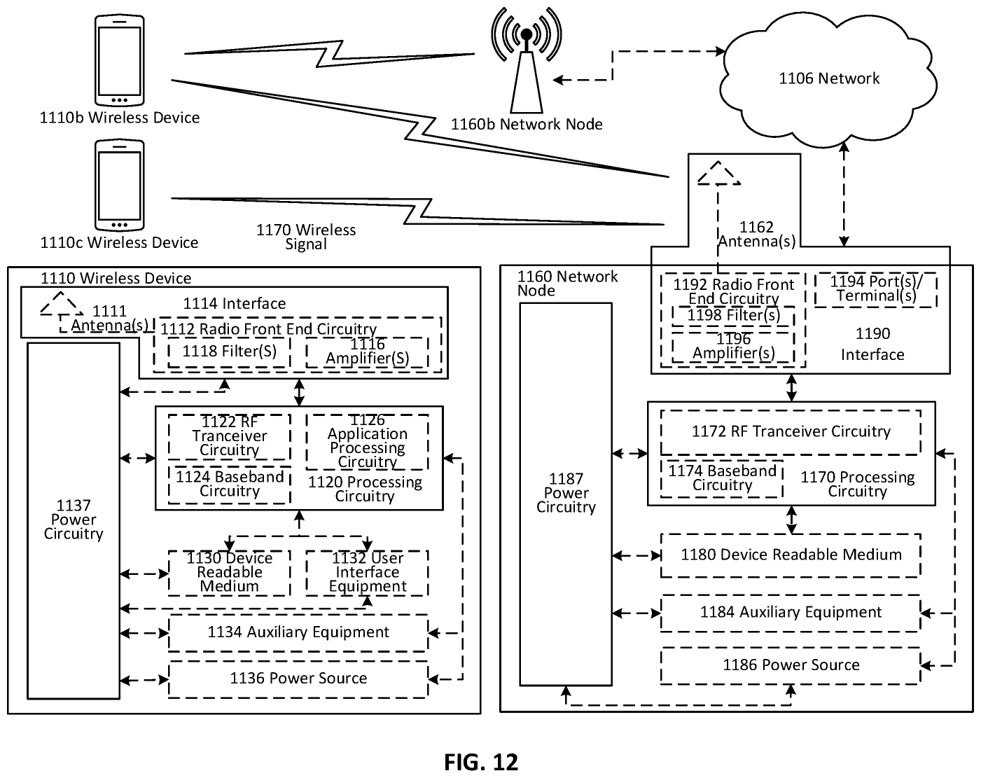

Although the subject matter described herein may be implemented in any appropriate type of system using any suitable components, the embodiments disclosed herein are described in relation to a wireless network, such as the example wireless network illustrated in FIG. 12. For simplicity, the wireless network of FIG. 12 only depicts network 1106, network nodes 1160 and 1160b, and WDs 1110, 1110b, and 1110c. In practice, a wireless network may further include any additional elements suitable to support communication between wireless devices or between a wireless device and another communication device, such as a landline telephone, a service provider, or any other network node or end device. Of the illustrated components, network node 1160 and wireless device (WD) 1110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), and base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 12, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 12 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1160 may be configured to support multiple radio access technologies (RATs). In such embodiments, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 is configured to perform any determining, calculating, or similar operations (e.g., certain obtaining operations) described herein as being provided by a network node. These operations performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features, functions, or benefits discussed herein. In some embodiments, processing circuitry 1170 may include a system on a chip (SOC).

In some embodiments, processing circuitry 1170 may include one or more of radio frequency (RF) transceiver circuitry 1172 and baseband processing circuitry 1174. In some embodiments, radio frequency (RF) transceiver circuitry 1172 and baseband processing circuitry 1174 may be on separate chips (or sets of chips), boards, or units, such as radio units and digital units. In alternative embodiments, part or all of RF transceiver circuitry 1172 and baseband processing circuitry 1174 may be on the same chip or set of chips, boards, or units.

In certain embodiments, some or all of the functionality described herein as being provided by a network node, base station, eNB or other such network device may be performed by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 is used in the wired or wireless communication of signaling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain embodiments a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other embodiments, the interface may comprise different components and/or different combinations of components.

In certain alternative embodiments, network node 1160 may not include separate radio front end circuitry 1192, instead, processing circuitry 1170 may comprise radio front end circuitry and may be connected to antenna 1162 without separate radio front end circuitry 1192. Similarly, in some embodiments, all or some of RF transceiver circuitry 1172 may be considered a part of interface 1190. In still other embodiments, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1162 may be separate from network node 1160 and may be connectable to network node 1160 through an interface or port.

Antenna 1162, interface 1190, and/or processing circuitry 1170 may be configured to perform any receiving operations and/or certain obtaining operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and is configured to supply the components of network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative embodiments of network node 1160 may include additional components beyond those shown in FIG. 12 that may be responsible for providing certain aspects of the network node's functionality, including any of the functionality described herein and/or any functionality necessary to support the subject matter described herein. For example, network node 1160 may include user interface equipment to allow input of information into network node 1160 and to allow output of information from network node 1160. This may allow a user to perform diagnostic, maintenance, repair, and other administrative functions for network node 1160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1114 is connected to antenna 1111 and processing circuitry 1120, and is configured to condition signals communicated between antenna 1111 and processing circuitry 1120. Radio front end circuitry 1112 may be coupled to or a part of antenna 1111. In some embodiments, WD 1110 may not include separate radio front end circuitry 1112; rather, processing circuitry 1120 may comprise radio front end circuitry and may be connected to antenna 1111. Similarly, in some embodiments, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other embodiments, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other embodiments, the processing circuitry may comprise different components and/or different combinations of components. In certain embodiments processing circuitry 1120 of WD 1110 may comprise a SOC. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120.

In certain embodiments, some or all of the functionality described herein as being performed by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g., certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g., the number of gallons used) or a speaker that provides an audible alert (e.g., if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g., an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

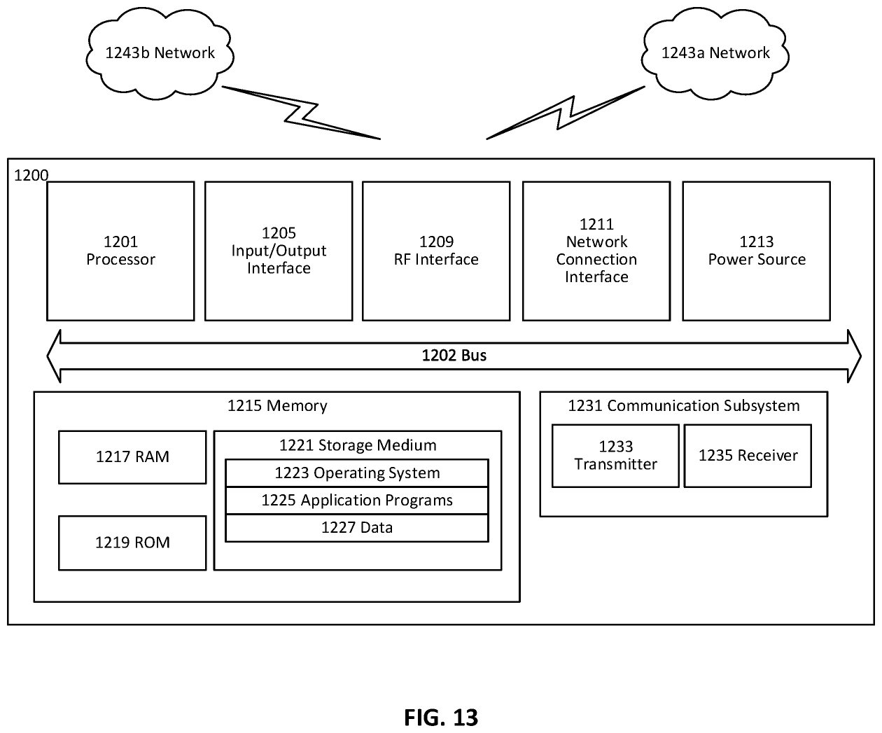

FIG. 13 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 12200 may be any UE identified by the 3rd Generation Partnership Project (3GPP), including a NB-IoT UE, a machine type communication (MTC) UE, and/or an eMTC UE. UE 1200, as illustrated in FIG. 13, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 13 is a UE, the components discussed herein are equally applicable to a WD, and vice-versa.

In FIG. 13, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 includes operating system 1223, application program 1225, and data 1227. In other embodiments, storage medium 1221 may include other similar types of information. Certain UEs may utilize all of the components shown in FIG. 13, or only a subset of the components. The level of integration between the components may vary from one UE to another UE. Further, certain UEs may contain multiple instances of a component, such as multiple processors, memories, transceivers, transmitters, receivers, etc.

In FIG. 13, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 13, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 13, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols, such as IEEE 802.12, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a local-area network (LAN), a wide-area network (WAN), a computer network, a wireless network, a telecommunications network, another like network or any combination thereof. For example, network 1243b may be a cellular network, a W-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

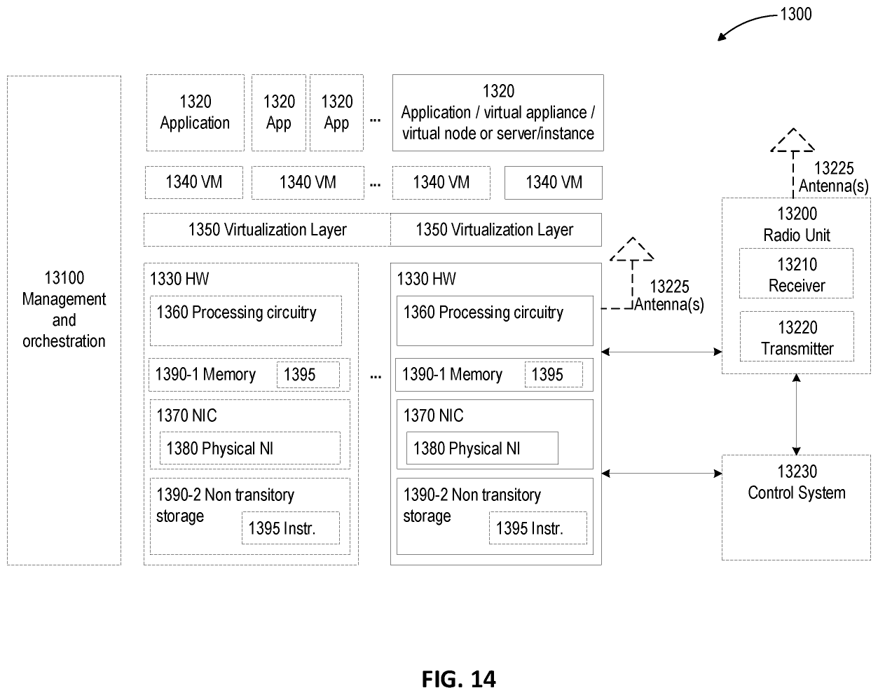

FIG. 14 is a schematic block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g., a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the embodiments disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated Application Specific Integrated Circuits (ASICs), or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware device may also include non-transitory, persistent, machine-readable storage media 1390-2 having stored therein software 1395 and/or instructions executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340, comprise virtual processing, virtual memory, virtual networking or interface and virtual storage, and may be run by a corresponding virtualization layer 1350 or hypervisor. Different embodiments of the instance of virtual appliance 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 13, hardware 1330 may be a standalone network node with generic or specific components. Hardware 1330 may comprise antenna 13225 and may implement some functions via virtualization. Alternatively, hardware 1330 may be part of a larger cluster of hardware (e.g., such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1340 may be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 13.

In some embodiments, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station.

In some embodiments, some signaling can be effected with the use of control system 13230 which may alternatively be used for communication between the hardware nodes 1330 and radio units 13200.

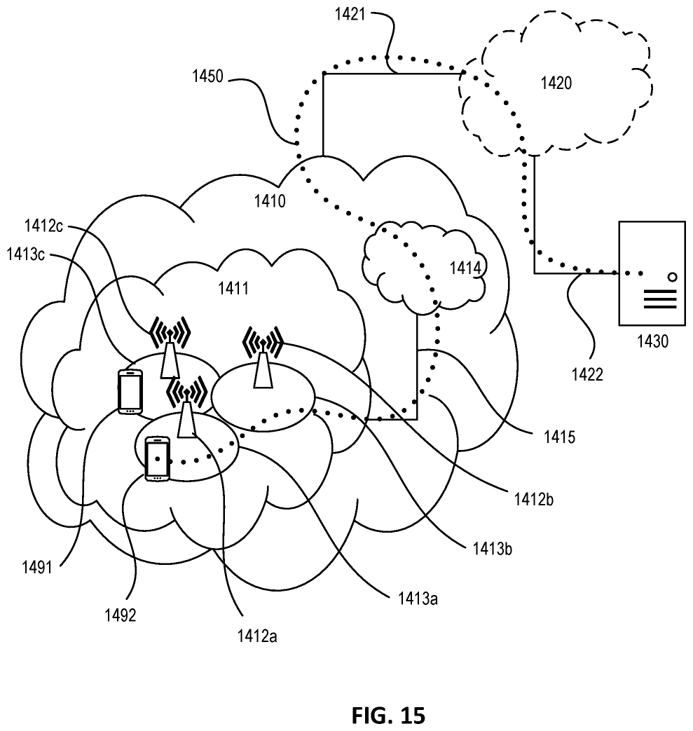

FIG. 15 illustrates a telecommunication network connected via an intermediate network to a host computer in accordance with some embodiments. In particular, with reference to FIG. 15, in accordance with an embodiment, a communication system includes telecommunication network 1410, such as a 3GPP-type cellular network, which comprises access network 1411, such as a radio access network, and core network 1414. Access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. A first UE 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

Telecommunication network 1410 is itself connected to host computer 1430, which may be embodied in the hardware and/or software of a standalone server, a cloud-implemented server, and a distributed server or as processing resources in a server farm. Host computer 1430 may be under the ownership or control of a service provider, or may be operated by the service provider or on behalf of the service provider. Connections 1421 and 1422 between telecommunication network 1410 and host computer 1430 may extend directly from core network 1414 to host computer 1430 or may go via an optional intermediate network 1420. Intermediate network 1420 may be one of, or a combination of more than one of, a public, private or hosted network; intermediate network 1420, if any, may be a backbone network or the Internet; in particular, intermediate network 1420 may comprise two or more sub-networks (not shown).

The communication system of FIG. 15 as a whole enables connectivity between the connected UEs 1491, 1492 and host computer 1430. The connectivity may be described as an over-the-top (OTT) connection 1450. Host computer 1430 and the connected UEs 1491, 1492 are configured to communicate data and/or signaling via OTT connection 1450, using access network 1411, core network 1414, any intermediate network 1420 and possible further infrastructure (not shown) as intermediaries. OTT connection 1450 may be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

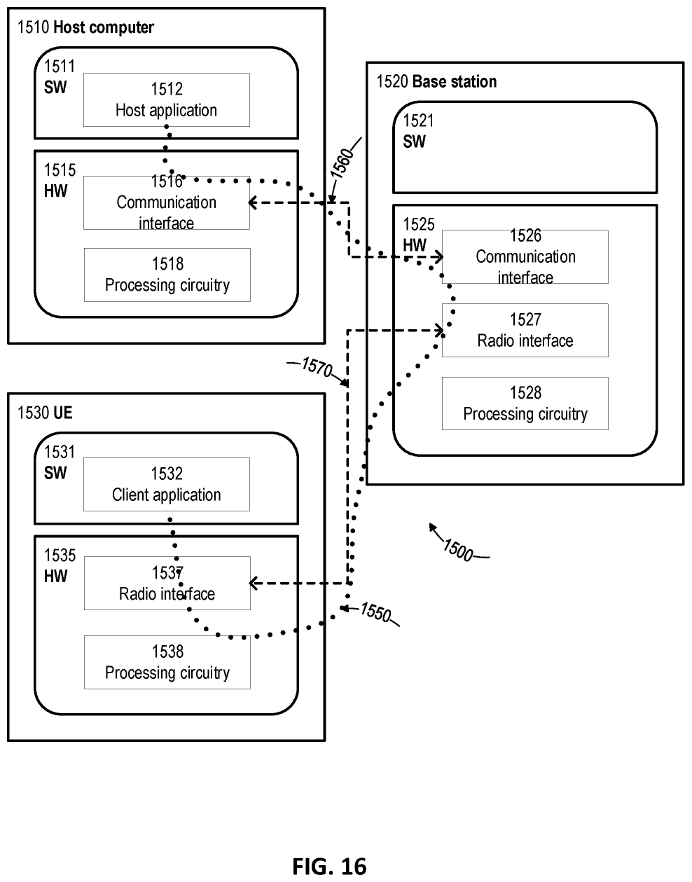

Example implementations, in accordance with an embodiment, of the UE, base station and host computer discussed in the preceding paragraphs will now be described with reference to FIG. 16. FIG. 16 illustrates host computer communicating via a base station with a user equipment over a partially wireless connection in accordance with some embodiments In communication system 1500, host computer 1510 comprises hardware 1515 including communication interface 1516 configured to set up and maintain a wired or wireless connection with an interface of a different communication device of communication system 1500. Host computer 1510 further comprises processing circuitry 1518, which may have storage and/or processing capabilities. In particular, processing circuitry 1518 may comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 may be operable to provide a service to a remote user, such as UE 1530 connecting via OTT connection 1550 terminating at UE 1530 and host computer 1510. In providing the service to the remote user, host application 1512 may provide user data which is transmitted using OTT connection 1550.

Communication system 1500 further includes base station 1520 provided in a telecommunication system and comprising hardware 1525 enabling it to communicate with host computer 1510 and with UE 1530. Hardware 1525 may include communication interface 1526 for setting up and maintaining a wired or wireless connection with an interface of a different communication device of communication system 1500, as well as radio interface 1527 for setting up and maintaining at least wireless connection 1570 with UE 1530 located in a coverage area (not shown in FIG. 16) served by base station 1520. Communication interface 1526 may be configured to facilitate connection 1560 to host computer 1510. Connection 1560 may be direct or it may pass through a core network (not shown in FIG. 16) of the telecommunication system and/or through one or more intermediate networks outside the telecommunication system. In the embodiment shown, hardware 1525 of base station 1520 further includes processing circuitry 1528, which may comprise one or more programmable processors, application-specific integrated circuits, field programmable gate arrays or combinations of these (not shown) adapted to execute instructions. Base station 1520 further has software 1521 stored internally or accessible via an external connection.

Communication system 1500 further includes UE 1530 already referred to. Its hardware 1535 may include radio interface 1537 configured to set up and maintain wireless connection 1570 with a base station serving a coverage area in which UE 1530 is currently located. Hardware 1535 of UE 1530 further includes processing circuitry 1538, which may comprise one or more programmable processors, application-specific integrated circuits, field programmable gate arrays or combinations of these (not shown) adapted to execute instructions. UE 1530 further comprises software 1531, which is stored in or accessible by UE 1530 and executable by processing circuitry 1538. Software 1531 includes client application 1532. Client application 1532 may be operable to provide a service to a human or non-human user via UE 1530, with the support of host computer 1510. In host computer 1510, an executing host application 1512 may communicate with the executing client application 1532 via OTT connection 1550 terminating at UE 1530 and host computer 1510. In providing the service to the user, client application 1532 may receive request data from host application 1512 and provide user data in response to the request data. OTT connection 1550 may transfer both the request data and the user data. Client application 1532 may interact with the user to generate the user data that it provides.

It is noted that host computer 1510, base station 1520 and UE 1530 illustrated in FIG. 16 may be similar or identical to host computer 1430, one of base stations 1412a, 1412b, 1412c and one of UEs 1491, 1492 of FIG. 15, respectively. This is to say, the inner workings of these entities may be as shown in FIG. 16 and independently, the surrounding network topology may be that of FIG. 15.

In FIG. 16, OTT connection 1550 has been drawn abstractly to illustrate the communication between host computer 1510 and UE 1530 via base station 1520, without explicit reference to any intermediary devices and the precise routing of messages via these devices. Network infrastructure may determine the routing, which it may be configured to hide from UE 1530 or from the service provider operating host computer 1510, or both. While OTT connection 1550 is active, the network infrastructure may further take decisions by which it dynamically changes the routing (e.g., on the basis of load balancing consideration or reconfiguration of the network).

Wireless connection 1570 between UE 1530 and base station 1520 is in accordance with the teachings of the embodiments described throughout this disclosure. One or more of the various embodiments improve the performance of OTT services provided to UE 1530 using OTT connection 1550, in which wireless connection 1570 forms the last segment. More precisely, the teachings of these embodiments may improve the continuity of service when performing an intra-RAT handover with a core network change and thereby provide benefits such as continuity of service and improved customer experience.

A measurement procedure may be provided for the purpose of monitoring data rate, latency and other factors on which the one or more embodiments improve. There may further be an optional network functionality for reconfiguring OTT connection 1550 between host computer 1510 and UE 1530, in response to variations in the measurement results. The measurement procedure and/or the network functionality for reconfiguring OTT connection 1550 may be implemented in software 1511 and hardware 1515 of host computer 1510 or in software 1531 and hardware 1535 of UE 1530, or both. In embodiments, sensors (not shown) may be deployed in or in association with communication devices through which OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of OTT connection 1550 may include message format, retransmission settings, preferred routing etc.; the reconfiguring need not affect base station 1520, and it may be unknown or imperceptible to base station 1520. Such procedures and functionalities may be known and practiced in the art. In certain embodiments, measurements may involve proprietary UE signaling facilitating host computer 1510's measurements of throughput, propagation times, latency and the like. The measurements may be implemented in that software 1511 and 1531 causes messages to be transmitted, in particular empty or ‘dummy’ messages, using OTT connection 1550 while it monitors propagation times, errors etc.

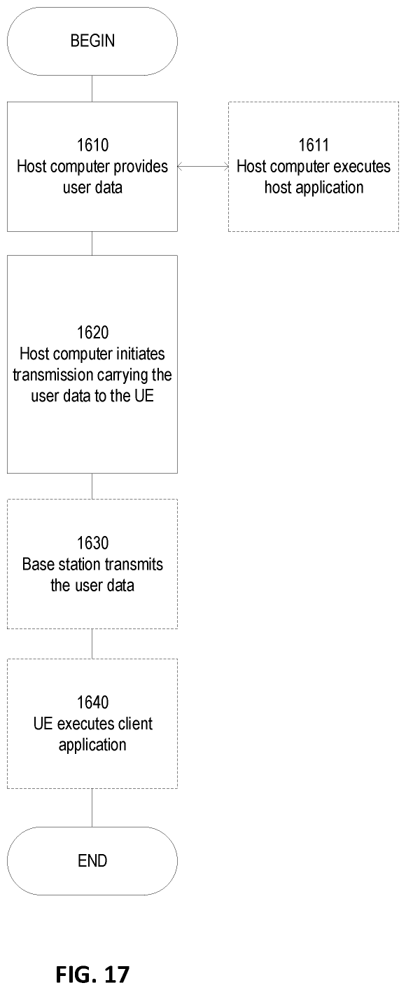

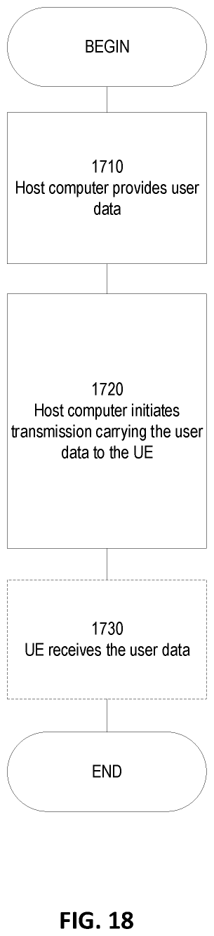

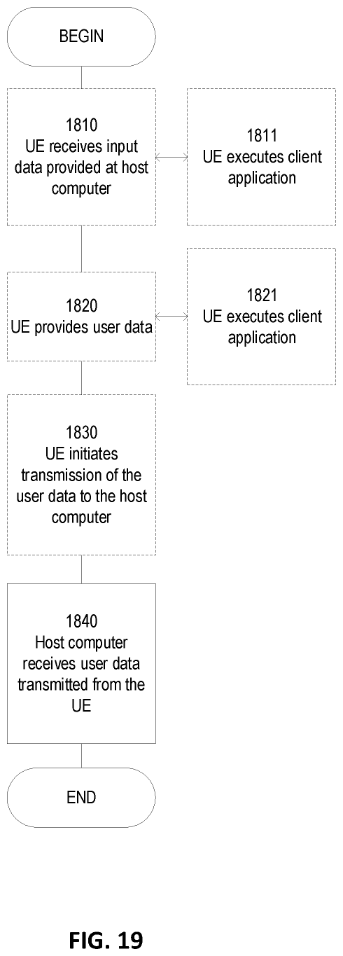

FIG. 17 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 17 will be included in this section. In step 1610, the host computer provides user data. In substep 1611 (which may be optional) of step 1610, the host computer provides the user data by executing a host application. In step 1620, the host computer initiates a transmission carrying the user data to the UE. In step 1630 (which may be optional), the base station transmits to the UE the user data which was carried in the transmission that the host computer initiated, in accordance with the teachings of the embodiments described throughout this disclosure. In step 1640 (which may also be optional), the UE executes a client application associated with the host application executed by the host computer.

FIG. 18 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 18 will be included in this section. In step 1710 of the method, the host computer provides user data. In an optional substep (not shown) the host computer provides the user data by executing a host application. In step 1720, the host computer initiates a transmission carrying the user data to the UE. The transmission may pass via the base station, in accordance with the teachings of the embodiments described throughout this disclosure. In step 1730 (which may be optional), the UE receives the user data carried in the transmission.

FIG. 19 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 19 will be included in this section. In step 1810 (which may be optional), the UE receives input data provided by the host computer. Additionally or alternatively, in step 1820, the UE provides user data. In substep 1821 (which may be optional) of step 1820, the UE provides the user data by executing a client application. In substep 1811 (which may be optional) of step 1810, the UE executes a client application which provides the user data in reaction to the received input data provided by the host computer. In providing the user data, the executed client application may further consider user input received from the user. Regardless of the specific manner in which the user data was provided, the UE initiates, in substep 1830 (which may be optional), transmission of the user data to the host computer. In step 1840 of the method, the host computer receives the user data transmitted from the UE, in accordance with the teachings of the embodiments described throughout this disclosure.

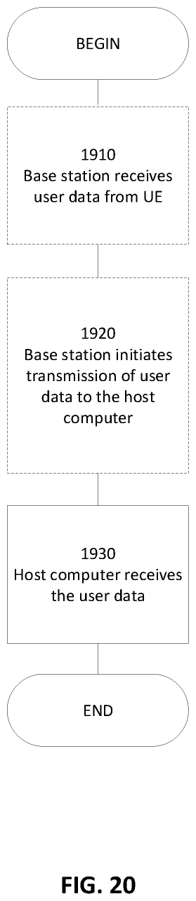

FIG. 20 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 20 will be included in this section. In step 1910 (which may be optional), in accordance with the teachings of the embodiments described throughout this disclosure, the base station receives user data from the UE. In step 1920 (which may be optional), the base station initiates transmission of the received user data to the host computer. In step 1930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. Additional information and embodiments may also be found in Appendices A and B attached hereto.

1. A method implemented by a network node in a wireless communication network of configuring wake-up signaling for a wireless device, the method comprising:
determining a paging probability type of the wireless device based on a paging probability of the wireless device, the paging probability indicating a likelihood that the wireless device will be paged in any given paging occasion with which the wireless device is associated, and the paging probability type indicating a group to which the wireless device belongs based on the paging probability of the wireless device; and
signaling the paging probability type of the wireless device to the wireless device, a base station for the wireless device, or both.

2. The method of claim 1, wherein the paging probability of the wireless device is determined based on at least one from a group consisting of a traffic type associated with the wireless device, a discontinuous reception configuration of the wireless device, a power saving mode (PSM) configuration of the wireless device, a paging configuration of the wireless device, a number of carriers used for paging, and a mobility of the wireless device.

3. The method of claim 1, wherein the one of the paging probability and paging probability type is signaled to the base station with a paging message.

4. The method of claim 1, wherein the one of the paging probability and paging probability type is determined by a mobility management entity and is signaled to the wireless device in a non-access stratum message.

5. The method of claim 1, wherein determining the paging probability type is further based on a false paging cost.

6. The method of claim 1, further comprising signaling, to at least one of the wireless device, and the base station of the wireless device, a number of paging probability types.

7.-17. (canceled)

18. A method implemented by a wireless device in a wireless communication network for reducing device energy consumption, the method comprising:
obtaining a paging probability type indicative of a paging probability of the wireless device, the paging probability indicating a likelihood that the wireless device will be paged in any given paging occasion with which the wireless device is associated, and the paging probability type indicating a group to which the wireless device belongs based on the paging probability of the wireless device;
determining a wake-up signal group to which the wireless device belongs based at least in part on the paging probability type; and
monitoring a downlink transmission for a wake-up signal directed to the wake-up signal group to which the wireless device belongs.

19. The method of claim 18 wherein obtaining the paging probability type indicative of a paging probability of the wireless device comprises receiving the paging probability type from a mobility management entity in the wireless communication network via non-access stratum signaling.

20. The method of claim 18 wherein obtaining the paging probability type indicative of a paging probability of the wireless device comprises receiving the paging probability type from a base station.

21. The method of claim 18, wherein determining a wake-up signal group to which the wireless device belongs comprises applying a predetermined mapping between paging probability types and wake-up signal groups.

22. The method of claim 21, wherein the predetermined mapping between paging probability types and wake-up signal groups is dependent on a number of paging probability types.

23. The method of claim 2Z wherein:
a number of paging probability groups exceeds a number of wake-up signal groups; and
the mapping associates two or more paging probability groups to at least one of the wake up signal groups.

24. The method of claim 2Z wherein:
a number of paging probability groups is less than a number of wake-up signal groups; and
the mapping splits a plurality of wireless device associated with at least one paging probability type between two or more wake-up signal groups.

25. The method of claim 24, wherein the mapping comprises splitting the plurality of wireless device associated with the at least one paging probability type between two or more wake-up signal groups based on a wireless device identification.

26. The method of claim 22, further comprising receiving the number of paging probability groups from one of a mobility management entity and a base station for the wireless device.

27. The method of claim 21, further comprising receiving mapping parameters for determining the predetermined mapping to the wireless device in system information broadcast by a base station.

28. The method of claim 18, further comprising:
receiving a wake-up signal addressed to the wake-up signal group to which the wireless device belongs; and
switching, responsive to the wake-up signal, an operating mode of the wireless device to receive a downlink transmission.

29. A network node in a wireless communication network comprising multiple network nodes, the network node being configured to:
determine a paging probability type of the wireless device based on a paging probability of the wireless device, the paging probability indicating a likelihood that the wireless device will be paged in any given paging occasion with which the wireless device is associated, and the paging probability type indicating a group to which the wireless device belongs based on the paging probability of the wireless device; and
signal the paging probability type of the wireless device to at least one of the wireless device, and a base station for the wireless device, or both.

30.-32. (canceled)

33. A wireless device in a wireless communication network comprising multiple network nodes, the wireless device being configured to:
obtain a paging probability type indicative of a paging probability of the wireless device, the paging probability indicating a likelihood that the wireless device will be paged in any given paging occasion with which the wireless device is associated, and the paging probability type indicating a group to which the wireless device belongs based on the paging probability of the wireless device;
determine a wake-up signal group to which the wireless device belongs based at least in part on the paging probability type; and
monitor a downlink transmission for a wake-up signal directed to the wake-up signal group to which the wireless device belongs.

34. (canceled)

35. The network node of claim 29, wherein the paging probability of the wireless device is determined based on at least one from a group consisting of a traffic type associated with the wireless device, a discontinuous reception configuration of the wireless device, a power saving mode (PSM) configuration of the wireless device, a paging configuration of the wireless device, a number of carriers used for paging, and a mobility of the wireless device.

36. The network node of claim 29, wherein the one of the paging probability and paging probability type is signaled to the base station with a paging message.

37. The network node of claim 29, wherein the one of the paging probability and paging probability type is determined by a mobility management entity and is signaled to the wireless device in a non-access stratum message.

38. The network node of claim 29, wherein determining the paging probability type is further based on a false paging cost.

39. The wireless device of claim 33, wherein the wireless device is further configured to obtain the paging probability type indicative of the paging probability of the wireless device by receiving the paging probability type from a mobility management entity in the wireless communication network via non-access stratum signaling.

40. The wireless device of claim 33, wherein the wireless device is further configured to determine a wake-up signal group to which the wireless device belongs by applying a predetermined mapping between paging probability types and wake-up signal groups.
